(19) United States
(12) Patent Application Publication
(10) Pub. No.: US 2026/0067781 A1
(43) Pub. Date: Mar. 5, 2026

(54) CONDITIONAL HANDOVER

(71) Applicant: Nokia Technologies Oy, Espoo (FI)

(72) Inventors: Umur KARABULUT, Munich (DE); Krzysztof KORDYBACH, Wroclaw (PL); Halit Murat GÜRSU, Munich (DE); Amaanat ALI, Espoo (FI); Panagiotis SPAPIS, Munich (DE); Ahmad AWADA, Munich (DE)

(21) Appl. No.: 19/104,194

(22) PCT Filed: Jul. 11, 2023
(86) PCT No.: PCT/EP2023/069166

§ 371 Date: Feb. 14, 2025

(30) Foreign Application Priority Data
Aug. 16, 2022 (GB) 2211946.5

(51) Int. Cl. H04W 36/36; H04W 36/00

(52) U.S. Cl. CPC H04W 36/362; H04W 36/0069

(57) ABSTRACT

In some examples a method, performed in a target master node (MN) of a radio network, for preparing handover of user equipment, UE, in dual connectivity, DC, where the handover is between primary cells (PCells) of source MNs and target MNs as well as the primary secondary cells (PSCells) between source secondary nodes (SNs) and target SNs, comprises transmitting, to the source MN, a CHO with DC configuration comprising a unique identifier for a UE defined between the source master node and the target secondary node, and for a secondary cell group (SCG) delta configuration, config1, of the target SN, receiving, from the Source MN, an indication representing a CPC procedure configured after transmission of the CHO with DC configuration, the unique identifier for the UE, and the identifier for the target SN, and transmitting a request to the target SN to prepare a second delta SCG configuration, config2, to be used by the UE in the event that a source MN initiated CPC procedure is executed.

### TECHNICAL FIELD

The present invention relates generally to fifth generation (5G) New Radio (NR) systems. Aspects relate to conditional handovers in 5G NR systems.

### BACKGROUND

The fifth generation (5G) New Radio (NR) system is designed to provide flexibility and configurability to optimize network services and types, accommodating various use cases. A new handover procedure provided as part of the 5G NR system enables user equipment (UE) to decide to perform handover when certain conditions are met. This NR handover procedure is called conditional handover (CHO) and executes in contrast to the legacy handover procedure in which the network was in charge of making the decision as to whether handover should be performed or not. It was thus a reactive process and prone to resulting handover failures.

CHO, on the other hand, is a handover that is executed by the UE when one or more handover execution conditions are met. Specifically, a UE can begin to evaluate the execution condition(s) upon receiving a CHO configuration, and may cease evaluation of the execution condition(s) once a handover is executed.

### SUMMARY

An objective of the present disclosure is to enable CHO-DC configuration validity for a target delta SCG configuration in the context of CHO-CPC coexistence, and avoidance of double resource reservation.

The foregoing and other objectives are achieved by the features of the independent claims.

Further implementation forms are apparent from the dependent claims, the description and the Figures.

A first aspect of the present disclosure provides a method, performed in a target master node (MN) of a radio network, for preparing handover of user equipment, UE, in dual connectivity, DC, where the handover is between primary cells (PCells) of source MNs and target MNs as well as the primary secondary cells (PSCells) between source secondary nodes (SNs) and target SNs, the method comprising transmitting, to the source MN, a CHO with DC configuration comprising a unique identifier for a UE defined between the source master node and the target secondary node, and a secondary cell group (SCG) delta configuration, config1, of the target SN, receiving, from the source MN, an indication representing a CPC procedure configured after transmission of the CHO with DC configuration, the unique identifier for the UE, and the identifier for the target SN, and transmitting a request to the target SN to prepare a second delta SCG configuration, config2, to be used by the UE in the event that a source MN initiated CPC procedure is executed.

In an implementation of the first aspect, the can further comprise receiving, from the target SN, config2, wherein the second delta SCG configuration valid in the event that the UE applies the SCG configuration after the CPC procedure is executed. The method can further comprise generating a second CHO with DC configuration using the second delta SCG configuration. The method can further comprise transmitting, to the source MN, a handover request update message, whereby to update the existing CHO with DC configuration. The second CHO with DC configuration can be maintained and used by the UE in the event that the CPC procedure is executed. The method can further comprise providing the second CHO with DC configuration to the UE, and instructing the UE to maintain the second CHO with DC configuration after the CPC procedure is executed.

A second aspect of the present disclosure provides a source master node in a radio network, the source master node comprising a processor, a memory coupled to the processor, the memory configured to store program code executable by the processor, the program code comprising one or more instructions, whereby to cause the source master node to receive, from a target MN, a CHO with DC configuration comprising a unique identifier for a UE defined between the source master node and a target SN, and a secondary cell group (SCG) delta configuration, config1, of the target SN, transmit, to the target MN, an indication representing a CPC procedure configured after transmission of the CHO with DC configuration, the unique identifier for the UE, and the identifier for the target SN, and receive, from the target MN, a handover request update message comprising a second CHO with DC configuration.

In an implementation of the second aspect, the program code can comprise one or more further instructions, whereby to cause the source master node to update the existing CHO with DC configuration with the second CHO with DC configuration. The program code can comprise one or more further instructions, whereby to cause the source master node to transmit the second CHO with DC configuration to the UE, and instruct the UE to maintain the second CHO with DC configuration after the CPC procedure is executed. The program code can comprise one or more further instructions, whereby to cause the source master node to transmit a CHO condition ID, related to the second CHO with DC configuration, to the UE.

A third aspect of the present disclosure provides user equipment, UE, comprising a processor, a memory coupled to the processor, the memory configured to store program code executable by the processor, the program code comprising one or more instructions, whereby to cause the UE to receive a second CHO with DC configuration from a source MN, and maintain the second CHO with DC configuration after a CPC procedure is executed.

In an implementation of the third aspect, the program code can comprise one or more further instructions, whereby to cause the UE to receive a CHO condition ID, related to the second CHO with DC configuration, from the source MN.

A fourth aspect of the present disclosure provides a machine-readable storage medium encoded with instructions for preparing handover of user equipment, UE, in dual connectivity, DC, where the handover is between primary cells (PCells) of source MNs and target MNs as well as the primary secondary cells (PSCells) between source secondary nodes (SNs) and target SNs, the instructions executable by a processor of the target master node, whereby to cause the target master node to transmit, to the source MN, a CHO with DC configuration comprising a unique identifier for a UE defined between the source master node and the target secondary node, and a secondary cell group (SCG) delta configuration, config1, of the target SN, receive, from the source MN, an indication representing a CPC procedure configured after transmission of the CHO with DC configuration, the unique identifier for the UE, and the identifier for the target SN, and transmit a request to the target SN to prepare a second delta SCG configuration, config2, to be used by the UE in the event that a source MN initiated CPC procedure is executed.

In an implementation of the fourth aspect, the machine-readable storage medium can be further encoded with instructions executable by the processor of the target master node, whereby to cause the target master node to receive, from the target SN, config2, wherein the second delta SCG configuration is valid in the event that the UE applies the SCG configuration after the CPC procedure is executed. The machine-readable storage medium can be further encoded with instructions executable by the processor of the target master node, whereby to cause the target master node to generate a second CHO with DC configuration using the second delta SCG configuration.

### BRIEF DESCRIPTION OF THE FIGURES

Embodiments will now be described by way of example only with reference to the figures, in which:

FIG. 1 is a schematic representation of a message flow according to an example;

FIG. 2 is a schematic representation of a message flow according to an example;

FIG. 3 is a schematic representation of a machine according to an example; and

FIG. 4 is a flow chart of a method according to an example.

### DETAILED DESCRIPTION

Example embodiments are described below in sufficient detail to enable those of ordinary skill in the art to embody and implement the systems and processes herein described. It is important to understand that embodiments can be provided in many alternate forms and should not be construed as limited to the examples set forth herein.

Accordingly, while embodiments can be modified in various ways and take on various alternative forms, specific embodiments thereof are shown in the drawings and described in detail below as examples. There is no intent to limit to the particular forms disclosed. On the contrary, all modifications, equivalents, and alternatives falling within the scope of the appended claims should be included. Elements of the example embodiments are consistently denoted by the same reference numerals throughout the drawings and detailed description where appropriate.

The terminology used herein to describe embodiments is not intended to limit the scope. The articles “a,” “an,” and “the” are singular in that they have a single referent, however the use of the singular form in the present document should not preclude the presence of more than one referent. In other words, elements referred to in the singular can number one or more, unless the context clearly indicates otherwise. It will be further understood that the terms “comprises,” “comprising,” “includes,” and/or “including,” when used herein, specify the presence of stated features, items, steps, operations, elements, and/or components, but do not preclude the presence or addition of one or more other features, items, steps, operations, elements, components, and/or groups thereof. The term “and/or” is only an association relationship for describing associated objects and represents that three relationships may exist such that A and/or B may indicate that A exists alone, A and B exist at the same time, or B exists alone. The character “/”generally represents that the associated objects are in an “or”relationship.

Unless otherwise defined, all terms (including technical and scientific terms) used herein are to be interpreted as is customary in the art. It will be further understood that terms in common usage should also be interpreted as is customary in the relevant art and not in an idealized or overly formal sense unless expressly so defined herein.

The following contains specific information related to implementations of the present disclosure. The drawings and their accompanying detailed disclosure are merely directed to implementations. However, the present disclosure is not limited to these implementations. Other variations and implementations of the present disclosure will be obvious to those skilled in the art.

The phrases “in one implementation,” or “in some implementations,” may each refer to one or more of the same or different implementations. The term “coupled” is defined as connected whether directly or indirectly through intervening components and is not necessarily limited to physical connections. The expression “at least one of A, B and C” or “at least one of the following: A, B and C” means “only A, or only B, or only C, or any combination of A, B and C.”

The terms “system”and “network”may be used interchangeably.

For the purposes of explanation and non-limitation, specific details such as functional entities, techniques, protocols, and standards are set forth for providing an understanding of the present disclosure. In other examples, detailed disclosure of well-known methods, technologies, systems, and architectures are omitted so as not to obscure the present disclosure with unnecessary details.

Persons skilled in the art will immediately recognize that any network function(s) or algorithm(s) disclosed may be implemented by hardware, software or a combination of software and hardware. Disclosed functions may correspond to modules which may be software, hardware, firmware, or any combination thereof

A software implementation may include machine-and/or computer-readable and/or executable instructions stored on a machine-and/or computer-readable medium such as memory or other types of storage devices. One or more microprocessors or general-purpose computers with communication processing capability may be programmed with corresponding executable instructions and perform the disclosed network function(s) or algorithm(s).

The microprocessors or general-purpose computers may include Applications Specific Integrated Circuitry (ASIC), programmable logic arrays, and/or using one or more Digital Signal Processor (DSPs). Although some of the disclosed implementations are oriented to software installed and executing on computer hardware, alternative implementations implemented as firmware or as hardware or as a combination of hardware and software are well within the scope of the present disclosure. The computer readable medium includes but is not limited to Random Access Memory (RAM), Read Only Memory (ROM), Erasable Programmable Read-Only Memory (EPROM), Electrically Erasable Programmable Read-Only Memory (EEPROM), flash memory, Compact Disc Read-Only Memory (CD-ROM), magnetic cassettes, magnetic tape, magnetic disk storage, or any other equivalent medium capable of storing computer-readable instructions.

A radio communication network architecture such as a Long Term Evolution (LTE) system, an LTE-Advanced (LTE-A) system, an LTE-Advanced Pro system, or a 5G NR Radio Access Network (RAN) typically includes at least one base station (BS), at least one user equipment (UE), and one or more optional network elements that provide connection within a network. The UE communicates with the network such as a Core Network (CN), an Evolved Packet Core (EPC) network, an Evolved Universal Terrestrial RAN (E-UTRAN), a 5G Core (5GC), or an internet via a RAN established by one or more BSs.

A UE may include but is not limited to a mobile station, a mobile terminal or device, or a user communication radio terminal. The UE may be a portable radio equipment that includes but is not limited to a mobile phone, a tablet, a wearable device, a sensor, a vehicle, or a Personal Digital Assistant (PDA) with wireless communication capability. The UE is configured to receive and transmit signals over an air interface to one or more cells in a RAN.

A BS can provide communication services according to at least a Radio Access Technology (RAT) such as Worldwide Interoperability for Microwave Access (WiMAX), Global System for Mobile communications (GSM) that is often referred to as 2G, GSM Enhanced Data rates for GSM Evolution (EDGE) RAN (GERAN), General Packet Radio Service (GPRS), Universal Mobile Telecommunication System (UMTS) that is often referred to as 3G based on basic wideband-code division multiple access (W-CDMA), high-speed packet access (HSPA), LTE, LTE-A, evolved LTE (eLTE) that is LTE connected to 5GC, NR (often referred to as 5G), and/or LTE-A Pro. However, the scope of the present disclosure is not limited to these protocols.

A BS may include but is not limited to a node B (NB) in the UMTS, an evolved node B (eNB) in LTE or LTE-A, a radio network controller (RNC) in UMTS, a BS controller (BSC) in the GSM/GERAN, a next generation (ng)-eNB in an Evolved Universal Terrestrial Radio Access (E-UTRA) BS in connection with 5GC, a next generation Node B (gNB) in the 5G-RAN, or any other apparatus capable of controlling radio communication and managing radio resources within a cell. A BS may serve one or more UEs via a radio interface.

A BS can provide radio coverage to a specific geographical area using a plurality of cells forming the RAN. The BS supports the operations of the cells. Each cell is operable to provide services to at least one UE within its radio coverage.

Each cell (often referred to as a serving cell) can provide services to serve one or more UEs within its radio coverage such that each cell schedules the downlink (DL) and optionally uplink (UL) resources to at least one UE within its radio coverage for DL and optionally UL packet transmissions. The BS can communicate with one or more UEs in the radio communication system via the plurality of cells.

A cell may allocate sidelink (SL) resources for supporting Proximity Service (ProSe) or Vehicle to Everything (V2X) service. Each cell may have overlapped coverage areas with other cells.

A frame structure for NR supports flexible configurations for accommodating various next generation (e.g., 5G) communication requirements such as Enhanced Mobile Broadband (eMBB), Massive Machine Type Communication (mMTC), and Ultra-Reliable and Low-Latency Communication (URLLC), while fulfilling high reliability, high data rate and low latency requirements. The Orthogonal Frequency-Division Multiplexing (OFDM) technology in the 3rd Generation Partnership Project (3GPP) may serve as a baseline for an NR waveform. The scalable OFDM numerology such as adaptive sub-carrier spacing, channel bandwidth, and Cyclic Prefix (CP) may also be used.

### Examples of Some Terms Used in the Present Disclosure Are:

Primary Cell (PCell): A PCell is the master cell group (MCG) cell, operating on the primary frequency, in which a UE either performs the initial connection establishment procedure or initiates the connection re-establishment procedure. A PCell is the special cell (SpCell) of the MCG.
Primary SCG Cell (PSCell): For dual connectivity (DC) operation, PSCell is the secondary cell group (SCG) cell in which the UE performs random access when performing the Reconfiguration with Sync procedure. PSCell is the SpCell of the SCG. In some implementations, the term PSCell may refer to a Primary Secondary Cell. The term “Primary SCG Cell” and the term “Primary Secondary Cell” may be used interchangeably in the present disclosure.
Special Cell (SpCell): For DC operation the term Special Cell (SpCell) refers to the PCell of the MCG or the PSCell of the SCG, otherwise the term Special Cell refers to the PCell.
Secondary Cell (SCell): For a UE configured with carrier aggregation (CA), SCell is a cell providing additional radio resources on top of Special Cell.
Serving Cell: For a UE in RRC_CONNECTED not configured with CA/DC there is only one serving cell comprising the primary cell. For a UE in RRC_CONNECTED configured with CA/DC the term “serving cells” is used to denote the set of cells comprising the Special Cell(s) and all secondary cells.
Master Cell Group (MCG): in MR-DC, MCG is a group of serving cells associated with the Master Node, comprising the SpCell (PCell) and optionally one or more SCells.
Master Node (MN): in MR-DC, a MN or primary node is the radio access node that provides the control plane connection to the core network. It may be a Master eNB (in EN-DC), a Master ng-eNB (in NGEN-DC) or a Master gNB (in NR-DC and NE-DC). In some implementations, a MN or primary node can comprise a source or target node for a UE.
Secondary Cell Group (SCG): in MR-DC, SCG is a group of serving cells associated with the Secondary Node, comprising of the SpCell (PSCell) and optionally one or more SCells.
Secondary Node (SN): in MR-DC, SN is the radio access node, with no control plane connection to the core network, providing additional resources to the UE. It may be an en-gNB (in EN-DC), a Secondary ng-eNB (in NE-DC) or a Secondary gNB (in NR-DC and NGEN-DC). In some implementations, a SN or secondary node can comprise a source or target node for a UE.

In a wireless communication network, such as E-UTRAN, one of the main causes of handover (HO) failure is a UE not receiving a Handover Command message from a source base station (e.g., a source eNB or a source gNB) or a serving base station (e.g., a serving eNB or a serving gNB). A conventional handover procedure is usually triggered by a measurement report from the UE. For example, when the serving cell's quality (e.g., signal strength and/or service quality) is below a preconfigured threshold and a neighbouring cell's quality (e.g., signal strength and/or service quality) is above a preconfigured threshold, the UE may send a measurement report to the source base station under the serving cell based on the received measurement configurations. Upon receiving the measurement report, the source base station may send a Handover Request message to multiple target base stations (e.g., eNB or gNB) for admission control, and receive Handover Acknowledgement messages from the target base stations. The source base station may select and send a Handover Command message (which may be included in a Handover Acknowledgement message from one of the target base stations) to the UE so that the UE can connect to the target cell.

The success of the overall handover procedure depends on several factors. One of the factors is that the serving cell quality does not drop rapidly within a short period of time, which may be dominated by the latency of the backhaul (e.g., for X2/Xn/Xx interface), the processing time of target base stations, and the signalling transmission time. However, in real-world situations, serving cell quality can drop quickly within a short period of time, and a UE may not successfully receive a Handover Command message before the serving cell quality drops significantly. As a result, the UE may detect a radio link failure. Consequently, in response to the detected radio link failure, the UE may initiate a radio resource control (RRC) Connection Re-establishment procedure, which in turn leads to a considerable amount of service interruption time.

In a next generation wireless network (e.g., a 5G NR network), with massive antenna beamforming in higher frequency bands, a serving cell quality may degrade even faster, especially when narrow beams are used to serve the UE. Blockage is another problem in NR deployments.

The 3GPP has introduced the concept of conditional handover (CHO) to improve reliability of the overall handover procedure. The CHO procedure may be viewed as a supplementary procedure to the conventional handover procedure to help reduce the handover failure rate.

To execute a conditional reconfiguration command, a UE may evaluate the triggering condition(s) associated with the conditional reconfiguration command to determine whether one or more triggering conditions (or executions conditions) for the conditional reconfiguration command is met. When the UE determines that a triggering condition is satisfied, the UE may apply the corresponding conditional reconfiguration command to connect to the target cell. Existing measurement events (e.g., A3 and A5) may be used for determining whether a triggering condition of a conditional reconfiguration command is satisfied.

CHO may help to improve reliability of the overall handover procedure. Applying concepts similar to CHO may also be beneficial to a PSCell addition procedure, a PSCell change procedure, an SN addition procedure, or an SN change procedure for MR-DC mode, because preparation between the MN and the SN and RRC signalling to add the SN may finish in advance.

A UE may behave differently when concepts of CHO (or conditional configuration) are applied to a normal HO (e.g., PCell change) procedure or a PSCell addition/change (or SN addition/change) procedure. For example, the UE may not need to release the link to the current PCell (or MN) if the executed conditional reconfiguration command is for PSCell addition/change. Some information or guideline (e.g., by implicit manner) for the UE to determine what to do when a conditional reconfiguration command is executed may be required. In addition, the principles for applying CHO (or conditional configuration) to PCell change and the principles for applying CHO (or conditional configuration) to PSCell addition/change may be different due to different purposes.

A conditional reconfiguration procedure may be a reconfiguration procedure executed by the UE when one or more execution conditions (also referred to as triggering conditions) are met.

There are three types of conditional reconfiguration. The first type is conditional reconfiguration for PCell change, also referred to as conditional reconfiguration for handover or conditional handover (CHO). The second type is conditional reconfiguration for PSCell change, also referred to as conditional PSCell change (CPC). The third type is conditional reconfiguration for PSCell addition, also referred to as conditional PSCell addition (CPA).

CHO may be a handover procedure that is executed by the UE when one or more handover execution conditions are met. The UE may start evaluating the execution condition(s) upon receiving the CHO configuration and may stop evaluating the execution condition(s) once the execution condition(s) is met. In some implementations, an execution condition may include, for example, A3/A5 events. In some implementations, an execution condition may consist of one or two trigger condition(s).

In the context of a CHO-CPC co-existence framework, there will are two configurations that are provided to a UE and that running in parallel. That is, the UE in question monitors both of the measurements for both configurations. One configuration is a CHO configuration with a CHO execution condition (either with or without DC connection, i.e., including SN connection), and the other configuration is a conditional PSCell change (CPC) configuration and CPC execution condition provided to the UE and which also run in parallel.

In a CHO-CPC co-existence scenario, a CPC validity problem occurs if the target MN prepares a CHO-DC with SN delta configuration. As such, a UE is served by a source MN and a source SN (i.e., a DC setup). The source MN can initiate a CHO preparation of a target MN where the target MN prepares a target SN (i.e., a CHO-DC preparation) with a target SN delta configuration. The target SN delta configuration will be applicable if the source SN is retained during the CHO preparation and execution of the target MN and UE applies the target SN delta configuration on the source SN configuration to obtain a full configuration that is needed for a target SN connection.

However, if the source SN changes after CHO preparation (but before CHO execution), the delta configuration becomes invalid as the serving SN of the UE changes and the delta configuration cannot be applied on the configuration of the new SN anymore. This invalidity is observed if the source MN prepares a CPC between the source SN and a target SN after CHO-DC preparation and if the CPC is executed before CHO-DC execution. In that case, i.e., the source SN changes before CHO-DC execution, the delta SN configuration of CHO-DC preparation becomes invalid. Hence the CHO preparation should be repeated.

In some cases, both serving and target MNs may prepare the same target SN for a UE, i.e., the target MN prepares the target SN for CHO-DC handover and the source MN prepares a CPC towards the same target SN. In that case, the target SN will not be aware that the same UE of the CHO-DC preparation is also prepared as part of a CPC preparation initiated by the source MN. Accordingly, the target SN will double-reserve resources even if the bearer configuration is the same.

Accordingly, in a CHO-CPC coexistence scenario, a serving MN can initiate a CHO preparation towards a target MN. The target MN can prepare a CHO-DC, i.e., for the target SN with delta configuration. Then, the target MN can prepare the UE in question with CPC towards the same target SN. In that case, the same target SN will reserve resources twice for the same UE since the serving MN prepares the same SN that the target MN has already prepared for CHO-DC configuration. Furthermore, the target SN delta configuration included in the CHO-DC configuration becomes invalid if the serving SN changes (due to the CPC that was prepared after CHO-DC preparation) before the CHO-DC execution as the delta configuration is prepared for the initial serving SN. To avoid the SN failure (due to invalid configuration usage), the CHO-DC preparation is re-initiated at the cost of extra signalling overhead and delayed CHO-DC configuration given to the UE.

In the given scenario, source MN prepares the target MN with CHO first and only later prepares the target SN with CPC. In case the target MN prepares a CHO-DC (with SN connection), the delta SCG configuration of the target MN's CHO-DC configuration becomes invalid if the CPC that is configurated by the source MN is executed first. The invalidation reason is that the delta SCG configuration of the target MN is configured to be used when the serving SN is not changed before and after the CHO-DC preparation. However, the solution differs from the signalling sequence point of view as the CPC preparation comes after the CHO preparation and CHO preparation needs to be updated after the CPC preparation is completed.

According to an example, in the context that a source MN prepares a CHO-DC first and subsequently prepares a target SN with CPC, the target MN's CHO-DC can be updated if the CPC preparation is handled after CHO-DC preparation. Furthermore, a target SN can be provided with information relating to a previous CHO-DC or CPC preparation for the same UE such that the target SN does not reserve double resources for the same UE.

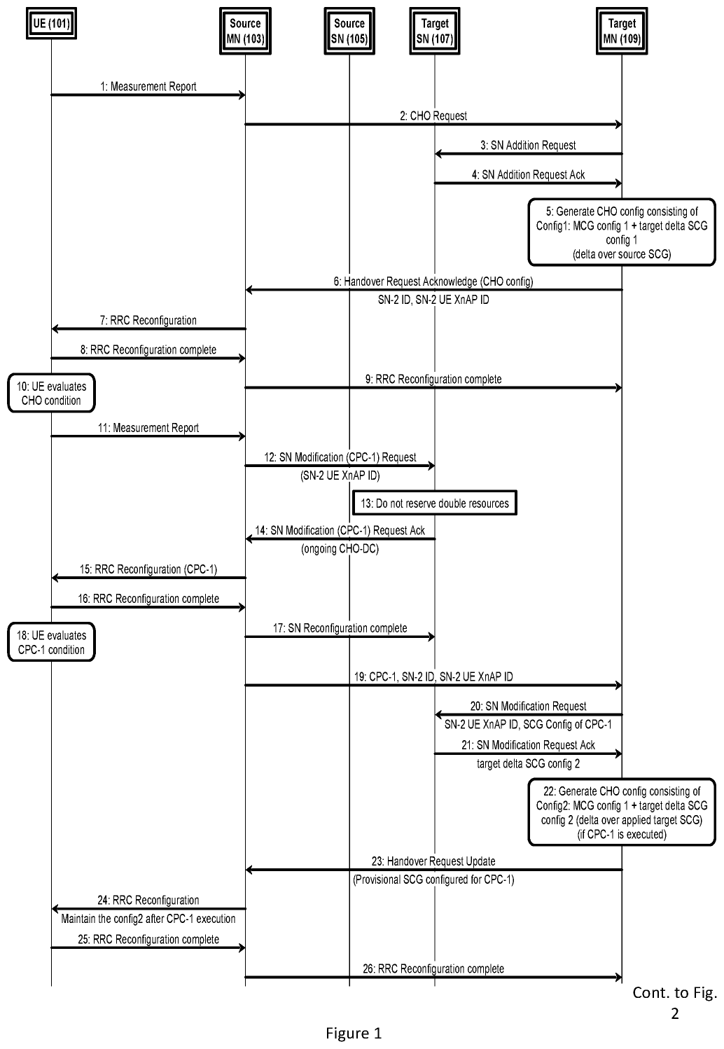

FIG. 1 is a schematic representation of a message flow according to an example. In the example of FIG. 1, the message flow relates to a method, performed in a target master node (MN) of a radio network, for preparing handover of user equipment, UE, in dual connectivity, DC, where the handover is between primary cell (PCells) of source and target MNs as well as the primary secondary cells (PSCells) between source and target secondary nodes (SNs).

UE 101 sends a measurement report (1) to its source master node 103 to initiate target master node 109 CHO preparation. The source master node 103 then sends (2) the CHO request to the target master node 109.

The target MN 109 prepares the target SN 107 for CHO-DC preparation and generates a CHO-DC config, config1, in block 5 which contains the delta SCG configuration 1 of the target SN 107. A handover request acknowledgement message (6) is sent from the target MN 109 to the source MN 103 and comprises the CHO-DC configuration prepared by the target MN 109.

According to an example, as part of the message (6), the target MN 109 also includes the SN UE XnAP ID that is defined between the target secondary node 107 and the source MN 103 during the CPC-1 preparation of the UE for communication over the Xn interface.

The CHO-DC configuration of the UE 101 is completed and UE 101 starts monitoring the CHO condition towards target PCell of the target MN 109 in block 10. UE 101 sends another measurement report (11) to source MN 103 to initiate the CPC preparation of the target PSCell in the target SN 107.

The source MN 109 sends an SN modification request (12) to prepare the CPC-1 between the source SN 105 and the target SN 107. As the request is sent to the target SN 107 that was indicated above (i.e., that specified with the SN ID), the source MN 103 forwards the SN UE XnAP ID to target SN 107 such that the target SN can identify the UE that has already been prepared by the target MN 109 in the CHO-DC preparation.

The target SN 107 may optimise resource allocation (13) if the bearer configuration allows for it, because it will become aware that the CPC is requested for the UE 101 that was already prepared by the target MN in the CHO-DC preparation. That is, double resources are not allocated at the target SN 107.

The target SN 107 replies to source MN's SN modification request (12) with acknowledgement (14). In an example, it will also indicate that the same UE 101 was prepared for a CHO-DC operation with the target MN 109.

CPC preparation configuration and the condition is provided to the UE and the CPC preparation is completed between UE 101, source MN 103 and target SN 107 (15-17). Hence, the UE starts monitoring the CPC-1 condition to execute the CPC-1 (18).

The source MN 105 informs (19) the target MN 109 about the Conditional PSCell Change CPC-1 preparation of the UE (12) so that the target MN is aware that the delta Secondary Cell Group SCG config of the target MN's CHO-DC configuration may become invalid if the CPC is executed before the CHO is executed. For that, the source MN 103 indicates the CPC-1, along with the SN ID and the SN UE XnAP ID that were sent from target MN 109 to source MN 103 message 6.

The target MN 109 requests (20) the target SN 107 to prepare a second delta SCG configuration that is to be used by the UE 101 if the CPC-1 is executed.

The target SN 107 sends (21) the target delta SCG configuration, config 2, to the target MN 109 that will be valid if the UE 101 applies the SCG config 2 after the CPC-1 is executed.

The target MN 109 generates (block 22) a second CHO-DC configuration using the target delta SCG config 2, and sends a handover request update message (23) to the source MN 103 to update the previous CHO-DC configuration. That is, it sends the second CHO-DC configuration to be maintained and used by the UE 101 if the CPC-1 is executed.

The source MN 103 relays (24) the second CHO-DC configuration to the UE 101 along with the CHO condition ID that is bound to the CHO-DC configuration and instructs UE 101 to maintain the second CHO-DC configuration after the CPC-1 is executed.

UE 101 notifies the source MN 103 about RRC reconfiguration complete (25) and the source MN 103 relays this information to target MN 109 (26).

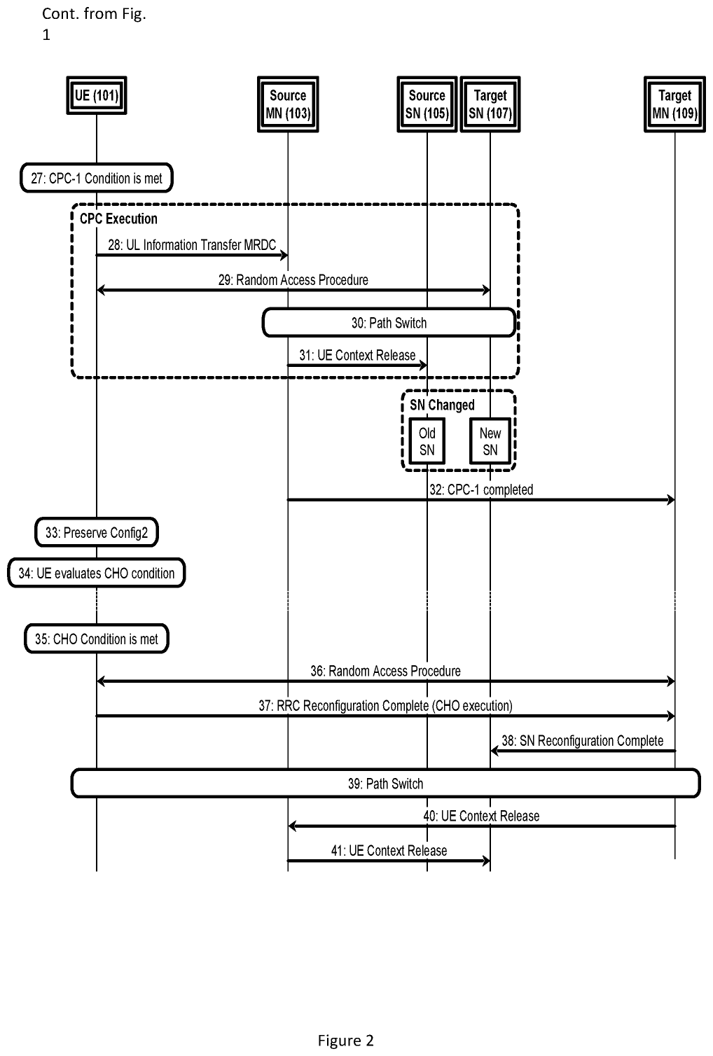

FIG. 2 is a schematic representation of a message flow according to an example and is a continuation of the message flow described above with reference to FIG. 1.

CPC-1 condition is met in block 27 and UE 101 hands over from the source SN 105 to the target SN 107 without changing source MN from source MN 103 (CPC Execution, 28-31). The target SN 107 becomes the new serving SN of the UE 101 (SN Changed). The target MN 109 is notified (32) about the CPC-1 execution, i.e., that the PSCell has changed from source SN 105 to target SN 107.

After the CPC-1 execution, UE 101 preserves the CHO-DC config 2 in block 33 as it was instructed to (24) and therefore has the valid delta SCG config 2 after CPC-1 execution (delta SCG config 2 is generated for the case that target SN 107 becomes the serving SN for UE 101). UE 101 continues monitoring the CHO condition towards target PCell of target MN 109 and once the condition is satisfied, UE executes the CHO-DC towards target MN 109 and target SN 107 and the handover procedure is completed (34-41).

Examples in the present disclosure can be provided as methods, systems or machine-readable instructions, such as any combination of software, hardware, firmware or the like. The machine-readable instructions may, for example, be executed by a machine such as a general-purpose computer, a platform comprising user equipment such as a smart device, e.g., a smart phone, and/or a network entity, such as a base station or node in a radio network for example. Modules of apparatus (for example, a module to generate a CHO configuration, a CHO with DC configuration, a CPC configuration and so on) may be implemented by a processor executing machine readable instructions stored in a memory, or a processor operating in accordance with instructions embedded in logic circuitry. The methods and modules may all be performed by a single processor or divided amongst several processors.

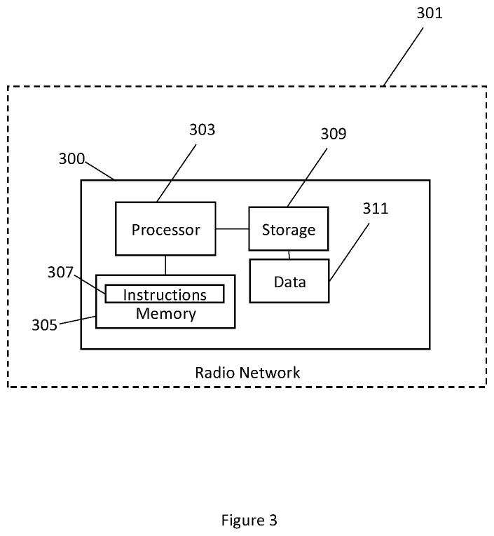

FIG. 3 is a schematic representation of a machine according to an example. The machine 300 can be, e.g., a node in a radio network. For example, the machine 300 can be a source master node 103 or a target master node 109 in a radio network 301. The machine 300 comprises a processor 303, and a memory 305 to store instructions 307, executable by the processor 303. The machine comprises a storage 309 that can be used to store data 311 representing any one or more of a CHO configuration, a CHO with DC configuration, a CPC configuration, an identifier for a UE and/or a node and so on, as described above. In an example, the instructions 307, executable by the processor 303, can cause the machine 300 to implement a method for preparing handover of user equipment, UE, in dual connectivity, DC, where the handover is between primary cells (PCells) of source MNs and target MNs as well as the primary secondary cells (PSCells) between source secondary nodes (SNs) and target SNs. The instructions, when executed by the processor 303, can cause the machine, such as a target master node to transmit, to the source MN, a CHO with DC configuration comprising a unique identifier for a UE defined between the source master node and the target secondary node, and a secondary cell group (SCG) delta configuration, config1, of the target SN, receive, from the source MN, an indication representing a CPC procedure configured after transmission of the CHO with DC configuration, the unique identifier for the UE, and the identifier for the target SN, and
transmit a request to the target SN to prepare a second delta SCG configuration, config2, to be used by the UE in the event that a source MN initiated CPC procedure is executed.

In an implementation, the machine can be a target master node or a source master node, and the instructions can be executable by a processor of the target master node or of the source master node.

In some examples, some methods can be performed in a cloud-computing or network-based environment. Cloud-computing environments may provide various services and applications via the Internet. These cloud-based services (e.g., software as a service, platform as a service, infrastructure as a service, etc.) may be accessible through a web browser or other remote interface of the user equipment for example. Various functions described herein may be provided through a remote desktop environment or any other cloud-based computing environment.

While various embodiments have been described and/or illustrated herein in the context of fully functional computing systems, one or more of these exemplary embodiments may be distributed as a program product in a variety of forms, regardless of the particular type of computer-readable-storage media used to actually carry out the distribution. The embodiments disclosed herein may also be implemented using software modules that perform certain tasks. These software modules may include script, batch, or other executable files that may be stored on a computer-readable storage medium or in a computing system. In some embodiments, these software modules may configure a computing system to perform one or more of the exemplary embodiments disclosed herein. In addition, one or more of the modules described herein may transform data, physical devices, and/or representations of physical devices from one form to another.

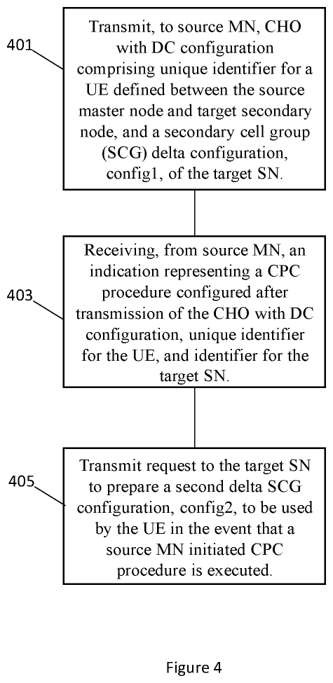

FIG. 4 is a flow chart of a method according to an example. In the example of FIG. 4, the method is suitable for preparing handover of user equipment, UE, in dual connectivity, DC, where the handover is between primary cells (PCells) of source MNs and target MNs as well as the primary secondary cells (PSCells) between source secondary nodes (SNs) and target SNs. In block 401, a CHO with DC configuration comprising a unique identifier for a UE defined between the source master node and target secondary node, and a secondary cell group (SCG) delta configuration, config1, of the target SN is transmitted to the source MN from the target MN. In block 403, the target MN receives, from the source MN, an indication representing a CPC procedure configured after transmission of the CHO with DC configuration, the unique identifier for the UE, and the identifier for the target SN. In block 405, a request is transmitted to the target SN to prepare a second delta SCG configuration, config2, to be used by the UE in the event that a source MN initiated CPC procedure is executed.

The preceding description has been provided to enable others skilled in the art to best utilize various aspects of the exemplary embodiments disclosed herein. This exemplary description is not intended to be exhaustive or to be limited to any precise form disclosed. Many modifications and variations are possible without departing from the spirit and scope of the instant disclosure. The embodiments disclosed herein should be considered in all respects illustrative and not restrictive. Reference should be made to the appended claims and their equivalents in determining the scope of the instant disclosure.

1-15. (canceled)

16. A method, performed in a target master node (MN) of a radio network, for preparing handover of user equipment, UE, in dual connectivity, DC, where the handover is between primary cells (PCells) of source MNs and target MNs as well as the primary secondary cells (PSCells) between source secondary nodes (SNs) and target SNs, the method comprising:
transmitting, to the source MN, a CHO with DC configuration comprising a unique identifier for a UE defined between the source master node and the target secondary node, and a secondary cell group (SCG) delta configuration, config1, of the target SN;
receiving, from the source MN, an indication representing a CPC procedure configured after transmission of the CHO with DC configuration, the unique identifier for the UE, and the identifier for the target SN; and
transmitting a request to the target SN to prepare a second delta SCG configuration, config2, to be used by the UE in the event that a source MN initiated CPC procedure is executed.

17. The method as claimed in claim 16, further comprising:
receiving, from the target SN, config2, wherein the second delta SCG configuration valid in the event that the UE applies the SCG configuration after the CPC procedure is executed.

18. The method as claimed in claim 16, further comprising:
generating a second CHO with DC configuration using the second delta SCG configuration.

19. The method as claimed in claim 18, further comprising:
transmitting, to the source MN, a handover request update message, whereby to update the existing CHO with DC configuration.

20. The method as claimed in claim 19, wherein the second CHO with DC configuration is maintained and used by the UE in the event that the CPC procedure is executed.

21. The method as claimed in any of claims 20, further comprising:
providing the second CHO with DC configuration to the UE; and
instructing the UE to maintain the second CHO with DC configuration after the CPC procedure is executed.

22. A source master node in a radio network, the source master node comprising:
a processor;
a memory coupled to the processor, the memory configured to store program code executable by the processor, the program code comprising one or more instructions, whereby to cause the source master node to:
receive, from a target MN, a CHO with DC configuration comprising a unique identifier for a UE defined between the source master node and a target SN, and a secondary cell group (SCG) delta configuration, config1, of the target SN;
transmit, to the target MN, an indication representing a CPC procedure configured after transmission of the CHO with DC configuration, the unique identifier for the UE, and the identifier for the target SN; and
receive, from the target MN, a handover request update message comprising a second CHO with DC configuration.

23. The source master node as claimed in claim 22, the program code comprising one or more further instructions, whereby to cause the source master node to:
update the existing CHO with DC configuration with the second CHO with DC configuration.

24. The source master node as claimed in claim 22, wherein the program code comprising one or more further instructions, whereby to cause the source master node to:
transmit the second CHO with DC configuration to the UE; and
instruct the UE to maintain the second CHO with DC configuration after the CPC procedure is executed.

25. The source master node as claimed in claim 24, wherein the program code comprising one or more further instructions, whereby to cause the source master node to:
transmit a CHO condition ID, related to the second CHO with DC configuration, to the UE.

26. User Equipment, UE, comprising:
a processor;
a memory coupled to the processor, the memory configured to store program code executable by the processor, the program code comprising one or more instructions, whereby to cause the UE to:
receive a second CHO with DC configuration from a source MN; and
maintain the second CHO with DC configuration after a CPC procedure is executed.

27. The UE as claimed in claim 26, wherein the program code comprising one or more further instructions, whereby to cause the UE to:
receive a CHO condition ID, related to the second CHO with DC configuration, from the source MN.

28. A machine-readable storage medium encoded with instructions for preparing handover of user equipment, UE, in dual connectivity, DC, where the handover is between primary cells (PCells) of source MNs and target MNs as well as the primary secondary cells (PSCells) between source secondary nodes (SNs) and target SNs, the instructions executable by a processor of the target master node, whereby to cause the target master node to:
transmit, to the source MN, a CHO with DC configuration comprising a unique identifier for a UE defined between the source master node and the target secondary node, and a secondary cell group (SCG) delta configuration, config1, of the target SN;
receive, from the source MN, an indication representing a CPC procedure configured after transmission of the CHO with DC configuration, the unique identifier for the UE, and the identifier for the target SN; and
transmit a request to the target SN to prepare a second delta SCG configuration, config2, to be used by the UE in the event that a source MN initiated CPC procedure is executed.

29. The machine-readable storage medium as claimed in claim 28, further encoded with instructions executable by the processor of the target master node, whereby to cause the target master node to:
receive, from the target SN, config2, wherein the second delta SCG configuration is valid in the event that the UE applies the SCG configuration after the CPC procedure is executed.

30. The machine-readable storage medium as claimed in claim 28, further encoded with instructions executable by the processor of the target master node, whereby to cause the target master node to:
generate a second CHO with DC configuration using the second delta SCG configuration.
